(19) United States
(12) Patent Application Publication
(10) Pub. No.: US 2010/0299947 A1
(43) Pub. Date: Dec. 2, 2010

(54) BRAKE MECHANISM FOR TAPE MEASURES

(76) Inventors: Michael John Levick, Essex (GB); Michael Elam, London (GB)

Correspondence Address: HARNESS, DICKEY & PIERCE, P.L.C., P.O. BOX 8910, RESTON, VA, 20195, US

(21) Appl. No.: 12/312,127

(22) PCT Filed: Nov. 2, 2007
(86) PCT No.: PCT/GB2007/004204

§ 371 Date: Jun. 4, 2009

(30) Foreign Application Priority Data
Nov. 2, 2006 (GB) 0621911.7

(51) Int. Cl. G01B 3/10

(52) U.S. Cl. 33/767

(57) ABSTRACT

A tape measuring is disclosed comprising a winding assembly having a winding handle, a support structure, the winding assembly being rotatably mounted on the support structure, a measuring tape attached to the winding assembly so as to be coilable thereon, and a brake mechanism operable on the measuring tape and/or the winding assembly to releasably brake the measuring tape. The brake mechanism is configured such that braking of the measuring tape can be released by coiling of the measuring tape onto the winding assembly using the winding handle. A brake application button is provided for applying the braking. A brake release button is also provided as another means for releasing braking in addition to the winding handle.

The present invention relates to tape measures and is particularly, although not necessarily exclusively, applicable to tape measures of a type known as ‘long tapes’.

Tape measures for distances of 10 metres or greater (so-called ‘long tapes’) tend to differ from those for shorter distances in that in most cases there is no spring mechanism for returning the measuring tape (generally referred to as a ‘blade’ in shorter tapes) to a spooled condition. To unwind the ‘long’ tape, the required length of measuring tape is simply pulled out. A winding handle is generally provided to spool the measuring tape; the measuring tape being rewound by turning this winding handle in the appropriate direction with one hand whilst gripping the tape measure with the other. The measuring tape itself generally has an end piece that includes a hook or loop or can be used in conjunction with a separate hook or peg to fix the measuring tape end to the ground.

One conventional form of ‘long tape’ has a winding drum or spool that is rotatably mounted on a frame. The measuring tape is attached at one end to the drum so that it can be coiled around the drum within the frame. At least one side face of the drum is exposed at an aperture in the frame. A winding handle is mounted on a centre moulding which is attached to (or located in) the exposed part of the side of the winding drum so that it can be used to return the measuring tape to its spooled condition.

The frame generally also includes a handle extending beyond and above the spooled tape, which can be grasped to hold the tape measure as the measuring tape is drawn out or rewound.

Many ‘long tapes’ are used by professionals, such as surveyors, estates agents and builders. They are often used to take many measurements in a short period of time. It is important that such tape measures are easy to use and enable very accurate measurements to be taken by a single operator. In particular, when taking a measurement it can be important to brake the measuring tape against movement (i.e. further uncoiling) so that the measuring tape can be placed under tension as the measurement is taken (the measuring tape (blade) of long tapes is calibrated at a given temperature and tension and is most accurate under these conditions. For flexible glass fibre reinforced PVC tapes, 20N at 20 deg C. is common. For steel and nylon coated steel, 50N at 20 deg C. is common.).

The braking of the measuring tape is often achieved by the operator simply applying manual pressure to the periphery of the coiled measuring tape with their thumb. It is also known to use the winding handle on a long tape or a separate lock mechanism to prevent rotation of the winding drum when the measuring tape is placed under tension but these arrangements are not easy to engage and the lock mechanism is not easily releasable.

According to a first aspect, the present invention provides a tape measure comprising:
a winding assembly having a winding handle;
a support structure, the winding assembly being rotatably mounted on the support structure;
a measuring tape attached to the winding assembly so as to be coilable thereon, and
a brake mechanism operable on the measuring tape and/or the winding assembly to releasably brake (i.e. resist uncoiling of) the measuring tape,
wherein the brake mechanism is configured such that braking of the measuring tape can be released by coiling of the measuring tape onto the winding assembly using the winding handle.

By having the brake mechanism configured in this way, use of the tape measure is simplified. The user can brake the measuring tape, e.g. so that the measuring tape can be placed under tension as a measurement is taken, without the measuring tape uncoiling; however, once the user has made the measurement, the user can simply coil the measuring tape onto the winding assembly to release the brake. This is particularly advantageous since coiling of the measuring tape onto the winding assembly is a common step a user may take after a measurement is taken, in order to prepare the tape measure for storage. Since, with the same action, the braking is released, the tape measure is placed in an appropriate state for re-use.

Preferably, the brake mechanism is applied using a button, referred to herein as the brake application button. Preferably, the tape measure comprises a button for releasing the brake, referred to herein as the brake release button. Thus, the tape measure may have two means for releasing the brake: the brake release button and the winding handle. Having a button to release the brake may be advantageous e.g. if coiling of the measuring tape using the winding handle to release the brake is undesirable or unpractical in certain situations. The brake application button and the brake release button may be the same button or they may be separate buttons.

The brake application button may be a push button, slider or a rocker button. Likewise, the brake release button may be a push button, slider or a rocker button.

Preferably, the support structure comprises a handle that extends radially beyond the coiled tape so that it can be grasped as the measuring tape is unwound. The brake application and release button's may be on the underside of the handle (i.e. the side facing towards the coiled tape) so that they can be depressed by one or more fingers of the hand grasping the handle to operate the brake mechanism. However, preferably the buttons are placed on top of the handle so that they are easily visible and distinguishable from one another.

According to a second aspect, the present invention provides a tape measure comprising:
a winding assembly having a winding handle;
a support structure, the winding assembly being rotatably mounted on the support structure;
a measuring tape attached to the winding assembly so as to be coilable thereon, and
a brake mechanism operable on the measuring tape and/or the winding assembly to releasably brake (i.e. resist uncoiling of) the measuring tape,
wherein the brake mechanism comprises a brake application button operable to brake the measuring tape, and a separate brake release button operable to release the braking of the measuring tape.

Preferably, the brake application and release buttons of the first and/or second aspect of the invention are arranged to move along different axes. For example, the brake application button may be arranged to move in a direction perpendicular to the support structure surface (e.g. it may be a push button that moves in and out of the support structure), and the brake release button may be arranged to move in a direction parallel to the support structure surface (e.g. it may be a slide button that slides along the support structure surface), or vice-versa. This arrangement may be provided as a way of distinguishing the two buttons, and/or may be provided to make the use of one button easier than the other. By having e.g. the push button easier to use than the slide button, application of the brake using the push button may be straightforward, whereas unintentional actuation of the slide button, and thus unintentional release of the brake mechanism, may be harder.

According to a third aspect, the present invention provides a tape measure assembly, including a winding assembly, a support structure and a brake mechanism, which can be assembled with a measuring tape in order to form a tape measure according to the first and/or second aspects set forth above.

An embodiment of the present invention will now be described by way of example only, with reference to the accompanying drawings, in which:—

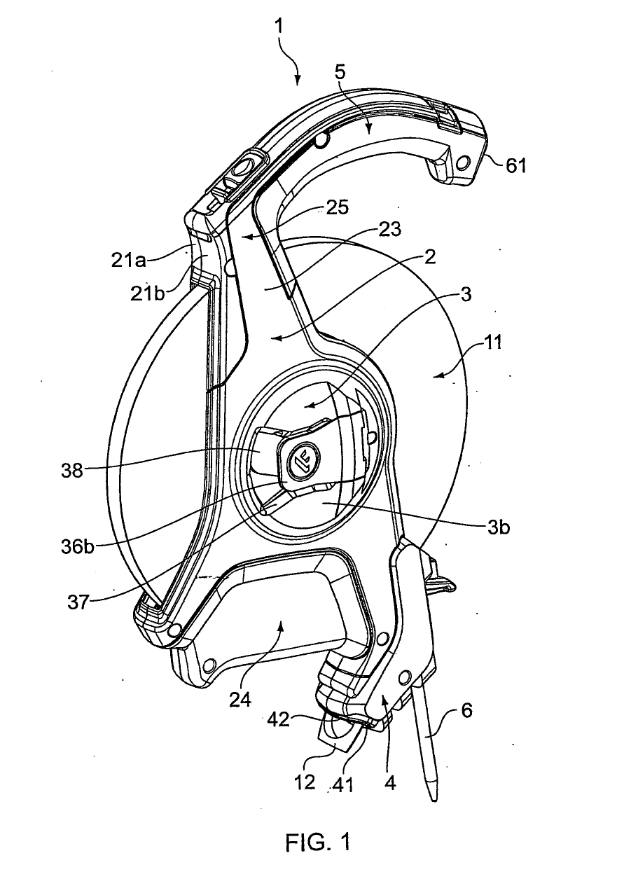

FIG. 1 is an oblique first side view of a tape measure in accordance with an embodiment of the present invention;

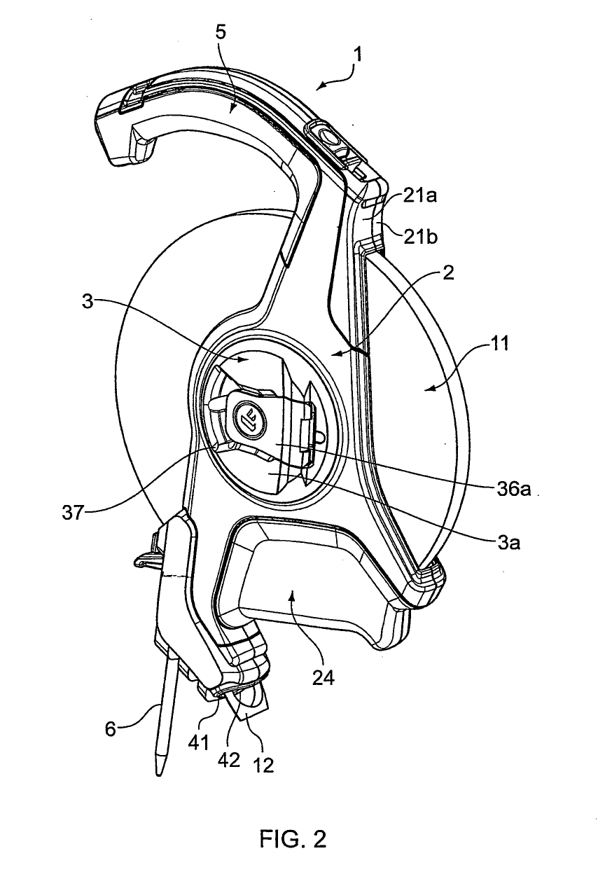

FIG. 2 is an oblique second side view of the tape measure of FIG. 1;

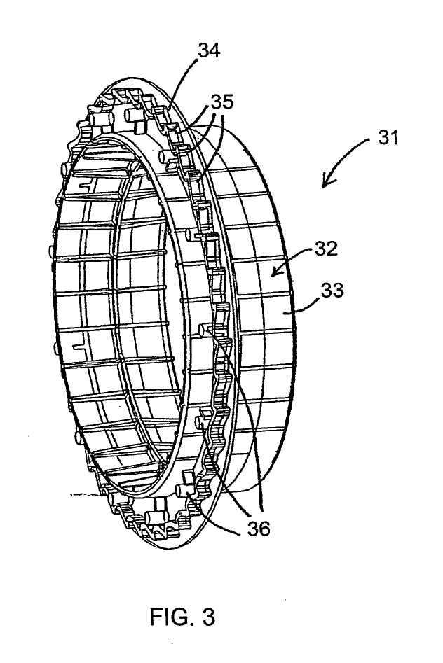

FIG. 3 is an oblique side view of a ratchet hub of the tape measure of FIG. 1;

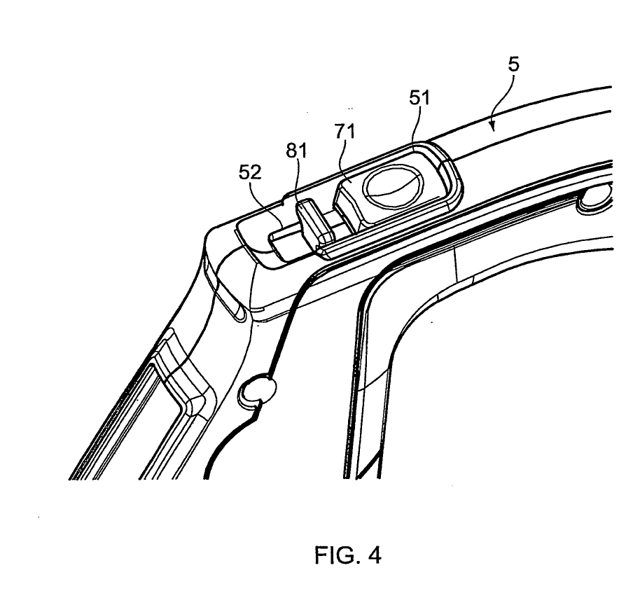

FIG. 4 is a close-up view of brake application and release buttons of the tape measure of FIG. 1;

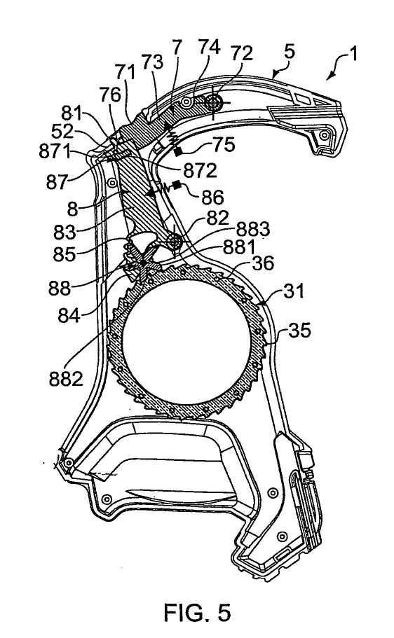

FIG. 5 is a cross-sectional side view of the tape measure of FIG. 1, with components of a braking mechanism shaded for ease of reference; and

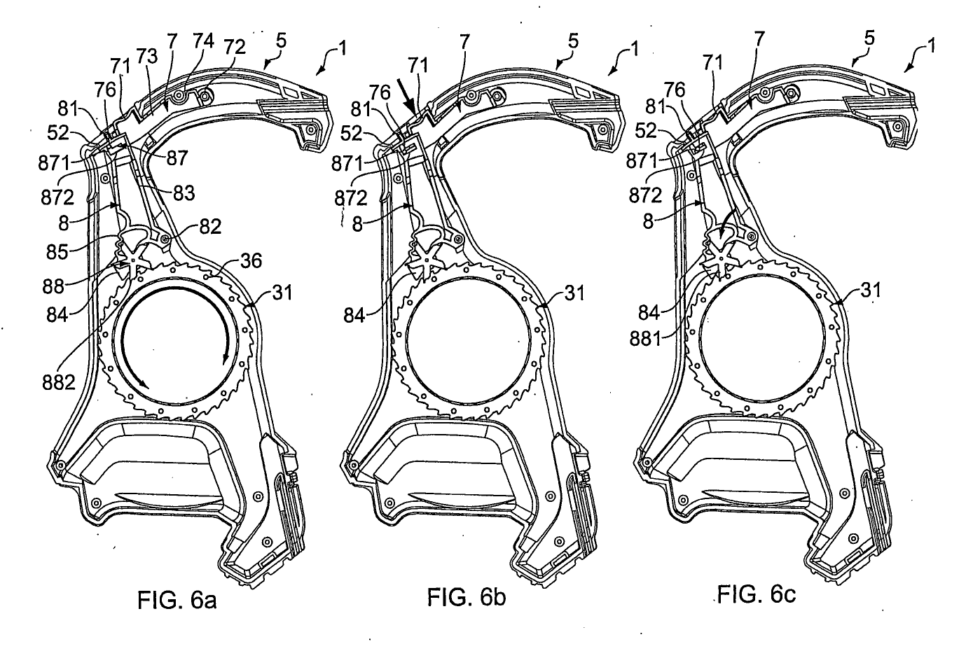

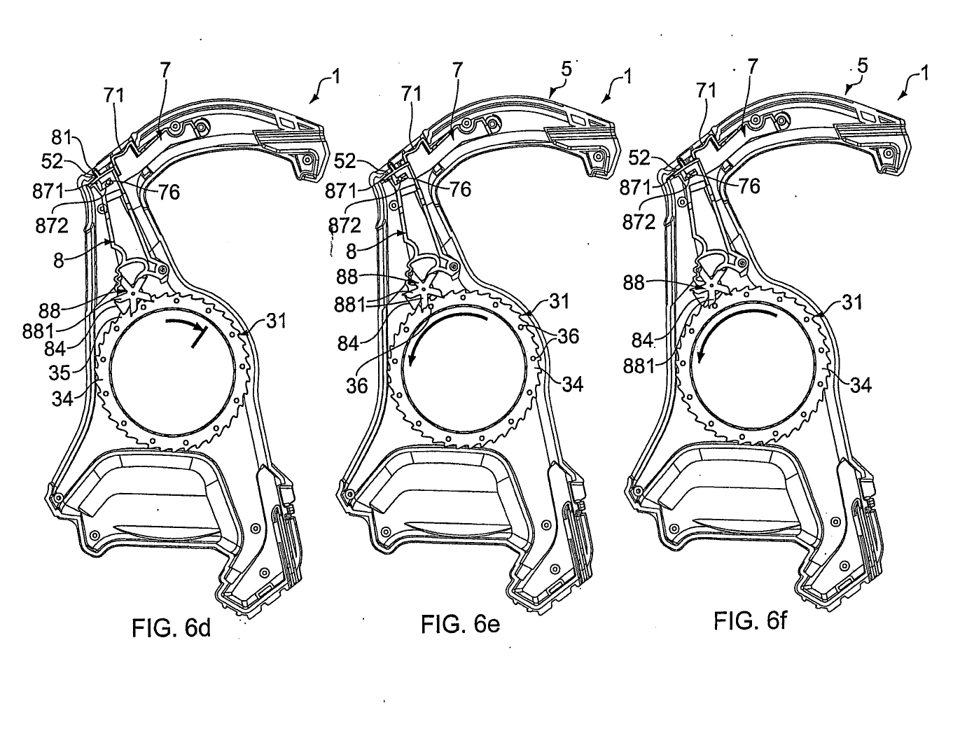

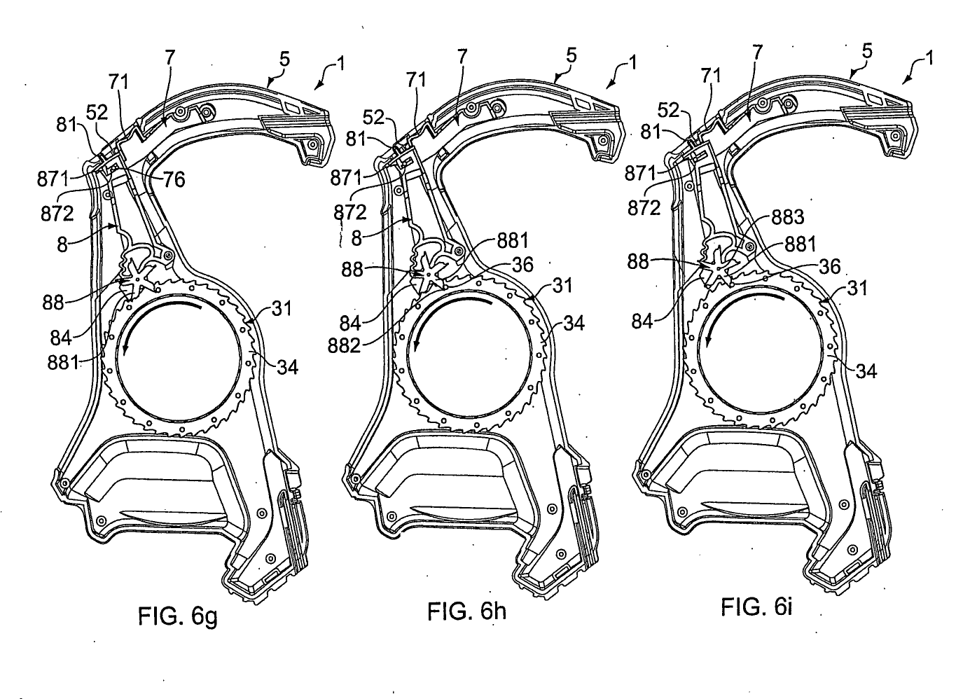

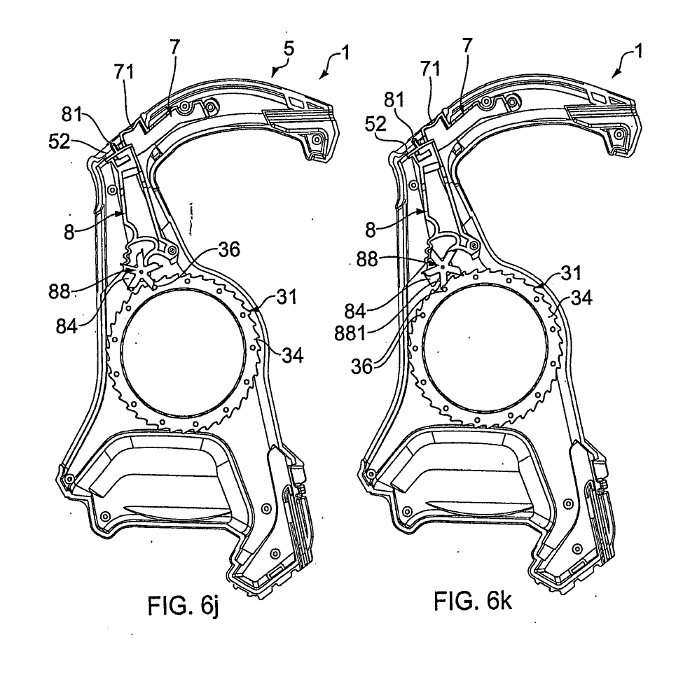

FIGS. 6a to 6k are cross-sectional views of the tape measure of FIG. 1, which illustrate operation of the braking mechanism.

In this description, the term ‘tape measure’ is used to describe the whole measuring device, including support structure, brake mechanism etc., whereas the term ‘measuring tape’ is used to describe the actual tape (or blade) that is coiled.

Referring to FIGS. 1 and 2, the tape measure 1 comprises a frame 2 made from a pair of injection moulded half shells 21a, 21b. The shells 21a, 21b are joined to one another by screws and/or other appropriate joining methods such as sonic welding or interlocking ‘click-fit’ features.

A winding assembly 3, on which a measuring tape 11 is wound, is rotatably mounted in a centre portion of the frame 2. The winding assembly comprises two centre mouldings 3a, 3b and a ratchet hub 31 (see FIG. 3) fixed between, and rotatable with, the two centre mouldings 3a, 3b. The ratchet hub 31 comprises a drum 32 with a circumferential outer surface 33. One end of a measuring tape 11 is attached to the winding assembly 3 either directly or by means of a flexible joining strip or ‘leader’, and the measuring tape 11 coils up around the drum's outer surface 33, within the frame 2. The other end of the measuring tape 11 terminates with a loop 12. A toothed annular flange 34, with a plurality of teeth 35, projects radially from one edge of the outer surface 33 of the drum 32.

The measuring tape 11 may be made of material conventionally used for long tapes, such as steel or glass fibre-reinforced plastic (PVC for example), and has a hook or loop 12 at its free end that can be used to fix that end to the ground or other reference position.

Two winding handles 36a, 36b are mounted on the winding assembly 3, one to each side. When either winding handle 36a, 36b is not in use it can lie within a channel 37 with its upper surface generally flush with the surface of the centre moulding 3a, 3b. When it is required to wind in (i.e. coil) the measuring tape 11, one of the handles 36a, 36b is turned to extend outwardly from the winding assembly 3, exposing a winding knob 38 rotatable on a spindle projecting from the handle 36a, 36b. The user can then grip the winding knob 38 to rotate the winding handle 36a, 36b in the appropriate direction to wind in the measuring tape 11. When the winding handle 36a, 36b is not in use, this spindle and winding knob 38 fit into a recess in the channel 37. A spring (not shown) biases the winding handle 36a, 36b to remain in either the outwardly extending position or located in the channel 37.

At the rear end of the base 24 of the frame member 2 there is an elongate snout portion 4 that protrudes downwardly beyond the coiled tape and is angled forward, in this example at about 45 degrees to the vertical. The snout 4 terminates in a mouth 41 that includes a slot 42 through which the measuring tape 11 is drawn off the coil. A series of guide elements within the snout 4 define a path for the measuring tape 11 to follow from the periphery of the tape coil to the mouth 41 of the snout 4. In use, the measuring tape 11 is drawn out through the slot 42 in the snout manually (e.g. by grasping the measuring tape 11 and pulling it through the slot 42 or by fixing the free end of the measuring tape 11 and then walking the tape measure 1 away from the fixed free end of the measuring tape 11) and rewound back through the snout 4 using one of the winding handles 36a, 36b in the manner described above.

The frame has a grip handle 5 that protrudes rearward from the top 25 of side walls 23 of the frame 2, above the coiled tape. The handle 5 is curved in the plane of the coiled tape to generally follow the perimeter of the coiled tape but is spaced sufficiently from it to allow a person to grasp the handle 5 with clearance between the measuring tape coil and their knuckles, even when the measuring tape 11 is fully rewound.

A removable ground engaging spike 6 is located at the rear end of the base 24 of the frame member 2. When not required, the spike 6 can be placed in a housing 61 at the end of the handle 5.

With reference to FIG. 4, mounted in a first aperture 51 on the top side of the handle 5 is a brake application button 71 that can be pushed with one or more fingers, e.g. when the handle 5 is grasped, so as to activate a brake mechanism. Mounted in a second aperture 52 on the top side of the handle 5, adjacent the first aperture 51, is a brake release button 81, which can be slid with one or more fingers, e.g. when the handle 5 is grasped, so as to release the brake mechanism. The brake mechanism will now be described in further detail with reference to FIG. 5 and FIGS. 6a to 6k; for simplicity, the measuring tape 11 is not shown in these drawings.

The brake application button 71 forms part of a one-piece component 7 (referred to herein as the first component 7) that is pivotally mounted to a pivot pin 72 provided in the handle 5. The first component 7 has a rigid elongate section 73 that extends from the pivot pin 72 across the bottom of the first aperture 51. The brake application button 71 branches upwardly from the elongate section 73 to locate in the first aperture 51. The elongate section 73 has an indent 74 to accommodate a screw that joins the injection moulded half shells 21a, 21b together. The first component 7 is spring-biased by a spring element (not shown) to move in a clockwise direction, about the pivot pin 72, as indicated by arrow 75.

The brake release button 81 forms part of another one-piece component 8 (referred to herein as the second component 8) that is pivotally mounted to a pivot pin 82 provided in the frame 2 adjacent the ratchet hub 31. For simplicity, the second component 8 can be considered generally triangular, with (e.g. as seen in FIG. 5), the brake release button 81 at the top corner of the triangle, the mounting point of the pivot pin 82 at the bottom right corner of the triangle, and a detent 84 at the bottom left corner of the triangle. A rigid elongate section 83 extends between the mounting point of the pivot pin 82 and the brake release button 81. Branching from the elongate section 83 is a flexible linkage 85, which connects the elongate section 83 to the detent 84. The second component 8 is spring-biased by a spring element (not shown) in an anticlockwise direction, about the pivot pin 82, as indicated by arrow 86.

The detent 84 is arranged to be releasably engageable with the teeth 35 of the toothed annular flange 34, whereupon it prevents rotation of the ratchet hub 31 (and winding assembly 3) in one direction (clockwise as seen in FIGS. 5 and 6a to 6k). In effect, when the detent 84 is engaged with the teeth 35 of the toothed annular flange 34, the measuring tape 11 can be coiled onto the drum 32 of the ratchet hub 31 (which causes disengagement of the detent 84 and the teeth 35 as described below), but can not be uncoiled from the drum 32 of the ratchet hub 31.

The first component 7 and the second component 8 are engaged with one another. In more detail, at an end of the elongate section of the first component 7, a pin 76 is provided which is slidably located in an L-shaped slot 87 situated at the top end of the elongate section 83 of the second component 8. A first branch 871 of the L-shaped slot 87 is aligned with the arc of rotation of the first component 7 and the other (second) branch 872 of the L-shaped slot 87 is aligned with the arc of rotation of the second component 8. The arrangement is such that, when the pin 76 is located in the first branch 871 of the L-shaped slot 87, the first component 7 is free to rotate (to a degree limited by the length of the first branch 871) but the second component 8 is prevented from rotating, and when the pin 76 is located in the second branch 872 of the slot 87, the second component 8 is free to rotate (to a degree limited by the length of the second branch 872) but the first component 7 is prevented from rotating.

The operation of the brake mechanism will now be described with reference to FIGS. 6a to 6k.

In FIG. 6a, the brake application button 71 is in a non-depressed state. The top surface of the button is flush with the surface of the handle 5. The pin 76 is located at the top the first branch 871 of the L-shaped slot 87, thus preventing any rotation of the second component 8. In this state, the detent 84 is separated from the ratchet hub 31 so that the ratchet hub 31 is free to rotate in either direction. Accordingly, the measuring tape 11 can be coiled or uncoiled by the user without obstruction.

In FIG. 6b, the brake application button 71 has been placed in a depressed state. As a result, the pin 76 has moved from the top to the bottom of the first branch 871 of the L-shaped slot 87 so as to lie at the left end of the second branch 872 of the L-shaped slot 87 as seen in FIG. 6b.

Since the pin 76 is now located at the left end of the second branch 872 of the L-shaped slot 87, the second component 8 can rotate anticlockwise, as can be seen by comparing FIGS. 6b, 6c and 6d. In fact, the second component 8 rotates anti-clockwise automatically, to its position shown in FIG. 6d, as a result of the spring-biasing discussed above. Since the pin 76 is located in the second branch 872 of the L-shaped slot 87, the first component 7 is prevented from rotating and the brake application button 71 is held in the depressed state.

Upon rotating to the position shown in FIG. 6d, the detent 84 of the second component 8 moves toward, and engages teeth 35 of the toothed annular flange 34 of the ratchet hub 31, thus preventing the ratchet hub 31 from rotating clockwise. Thus, the measuring tape 11 can not be uncoiled—it is braked. In this state, the user may place the measuring tape 11 under tension as a measurement is taken, without the measuring tape 11 uncoiling and impairing the measurement. The flexible linkage 85 of the second component 8 acts as a shock absorber to cushion impact between the detent 84 and the ratchet hub 31 upon engagement, thus preventing damage. This may be particularly useful if braking is applied whilst the ratchet hub 31 is rotating. Nevertheless, instead of a flexible linkage 85, a rigid linkage may be used to increase the strength of the second component 8, and reduce the risk of breakage during engagement between the detent 84 and the ratchet hub 31.

Although not shown, the second component 8 may comprise more than one detent 84, so that a plurality of teeth 35 can be engaged. For example, the second component 8 may comprise two detents, which can engage two teeth 35. By engaging more than one of the teeth 35, a more secure engagement between the second component 8 and the ratchet hub 31 may be achieved. Furthermore, the shock on engagement between the second component 8 and the ratchet hub 31, and when the measuring tape is pulled, may be spread between the detents, which is particularly advantageous if a rigid linkage is used instead of the flexible linkage 85.

To release the brake, the user has two options in this embodiment. The first option is to use the brake release button 81 (slider); the second option is to coil in the measuring tape 11.

Regarding the first option, as can be seen by comparing FIGS. 6c and 6d, when the second component 8 rotates anticlockwise so that the detent 84 engages the toothed annular flange 34 of the ratchet hub 31, the brake release button 81, which forms a part of the second component 8, also moves anticlockwise, generally passing from right to left in the second aperture 52. Thus, by simply sliding the brake release button 81 manually (against the biasing force of spring 86) in the opposite direction in the second aperture (i.e. from left to right), the second component 8 can be forced to rotate clockwise, whereupon the detent 84 disengages the toothed annular flange 34 of the ratchet hub 31, leaving the ratchet hub 31 free to rotate once again.

As the second component 8 is rotated clockwise by sliding the brake release button in the second aperture 52, the pin 76 moves left along the second branch 872 of the L-shaped slot 87, to a position at the bottom of the first branch 871 of the L-shaped slot 87. In this position, the pin 76 can move up the first branch 871 of the L-shaped slot 87, and thus the first component 7 can rotate clockwise. In fact, the first component 7 rotates clockwise automatically due to it being spring biased as discussed above. As it rotates clockwise, the brake application button 71 moves back to its non-depressed state as shown in FIG. 6a. Since; in this position, the pin 76 is now located at the top of the first branch 871 of the L-shaped slot 87, the second component 8 is prevented from rotating and re-engaging (and thus braking) the ratchet hub 31.

Regarding the second option, referring to FIG. 6e, to coil the measuring tape 11, the user rotates the ratchet hub 31 anticlockwise, using the winding handle 36a, 36b. (This is possible since the detent 84 only prevents clockwise rotation of the ratchet hub 31, as discussed above.) A plurality of pins 36 are located periodically along the side wall of the toothed annular flange 34, the pins 36 each projecting in a direction substantially parallel to the axis of rotation of the ratchet hub 31. An element, referred to herein as a yoke 88, is rotatably mounted to the second component 8, adjacent the detent 84. In this embodiment, the yoke 88 has five radially projecting prongs 881. When the detent 84 engages the ratchet hub 31, the yoke 88 is positioned such that at least one of the prongs 881 crosses the rotational path of the pins 36. Accordingly, when the ratchet hub 31 rotates anticlockwise, when the users coils the measuring tape 11, one of the pins 36 will engage one of the prongs 881, as shown in FIGS. 6f to 6h. For secure engagement, the prongs 881 have complimentary recesses 882 (see FIG. 5) into which the pins 36 locate upon engagement.

When the ratchet hub 31 is rotated anticlockwise, the detent 84 immediately rides over one or more of the teeth 35 (FIG. 6e). As the ratchet hub 31 rotates further, the edge of a first prong 881 engages and pushes a first pin 36 (FIG. 6f), causing the yoke 88 to rotate and position a second prong 881 for secure engagement of a second pin 36 within its recess 882 (FIGS. 6g and 6h). As the ratchet hub rotates still further, the second pin 36 pushes the second prong 881, causing the angle between the second prong 881 and the ratchet hub 31 to change such that the mounting point 883 of the yoke 88 and the second component 8 is forced away from the ratchet hub 31. This in turn forces the second component 8 to rotate clockwise (FIGS. 6i and 6j), whereupon the detent 84 fully disengages the toothed annular flange 34 of the ratchet hub 31, leaving the ratchet hub 31 free to rotate once again (FIG. 6k). The brake application button 71 moves back to its non-depressed state shown in FIGS. 5a, 6a and 6k in the same manner as described above with respect to the brake release button method (the only difference being that the yoke 88 and the ratchet hub 31 has been used to effect rotation of the second component 8, rather than the brake release button 72).

1. A tape measure comprising:
a winding assembly having a winding handle;
a support structure, the winding assembly being rotatably mounted on the support structure;
a measuring tape attached to the winding assembly so as to be coilable thereon, and
a brake mechanism operable on the measuring tape and/or the winding assembly to releasably brake the measuring tape,
wherein the brake mechanism comprises a brake application button operable to brake the measuring tape, and a separate brake release button operable to release the braking of the measuring tape.

2. The tape measure of claim 1, wherein the brake application button and the brake release button are arranged to move along substantially perpendicular axes.

3. The tape measure according to claim 1, wherein one of the brake application button and the brake release button is a push button, and the other is a slider.

4. The tape measure of claim 3, wherein the brake application button is the push button and the brake release button is the slider.

5. The tape measure of claim 1, wherein the brake mechanism is configured such that braking of the measuring tape can be released by coiling of the measuring tape onto the winding assembly using the winding handle.

6. The tape measure according to claim 1, wherein the winding assembly comprises a ratchet hub, the measuring tape being coilable on the ratchet hub.

7. The tape measure of claim 6, wherein the braking mechanism comprises a first component comprising the brake application button, and a second component comprising both the brake release button and a detent for releasably engaging the ratchet hub, wherein the first and second components are relatively rotatable.

8. The tape measure of claim 7, wherein the first and second components are spring biased to rotate in opposite directions.

9. The tape measure of claim 7, wherein one of the first and second components comprises a pin slideable within an L-shaped slot provided in the other of the first and second components.

10. The tape measure of claim 7, comprising an element rotatably mounted on the second component for engaging one or more pins positioned circumferentially on the ratchet hub, for releasing the detent from engagement with the ratchet hub.

11. The tape measure of claim 1, wherein the support structure comprises a handle that extends radially beyond the coiled tape.

12. The tape measure of claim 11, wherein the brake application button and/or the brake release button is located on the underside of the handle of the support structure.

13. The tape measure of claim 11, wherein the brake application button and/or the brake release button is located on top of the handle of the support structure.

14. A tape measure assembly, including a winding assembly, a support structure and a brake mechanism, which can be assembled with a measuring tape in order to form a tape measure according to claim 1.
